(19) United States
(12) Patent Application Publication
(10) Pub. No.: US 2007/0297759 A1
(43) Pub. Date: Dec. 27, 2007

(54) Copy Protection For Audio, Video, and/or A/V Navigation Data

(76) Inventors: Volkmar Breitfeld, Dortmund (DE); Anders Fogh, Dortmund (DE); Tobias Taschner, Dortmund (DE)

Correspondence Address: ST. ONGE STEWARD JOHNSTON & REENS, LLC, 986 BEDFORD STREET, STAMFORD, CT, 06905-5619, US

(21) Appl. No.: 11/618,395

(22) Filed: Dec. 29, 2006

(30) Foreign Application Priority Data
May 11, 2006 (DE) 10 2006 022 268.7

(51) Int. Cl. H04N 5/91

(52) U.S. Cl. 386/94

(57) ABSTRACT

A method for protecting against copying of audio, video, and/or A/V navigation data that can be captured by means of a data carrier of a predetermined specification that can be used by a device for reproducing audio and/or video data, such that audio, video, and/or A/V navigation data are arranged in a data structure that meets the specifications. To improve the protection of such data carriers against unauthorized copying, at least one modification of at least one portion of audio, video, and/or A/V navigation data that are to be protected is proposed in the data structure arrangement. A data carrier, which includes audio, video, and/or A/V navigation data of the carrier in a data structure arrangement that meets at least a predetermined specification, so that the data structure arrangement is configured according to a method according to the invention.

### CROSS-REFERENCE TO RELATED APPLICATIONS

The present application claims priority of German Patent Application No. 10 2006 022 268.7 filed on May 11, 2006, the content of which is incorporated herein by reference.

### FIELD OF THE INVENTION

The present invention relates to a method for protecting against copying of audio, video, and/or A/V navigation data that can be captured by means of a data carrier of a predetermined specification that can be used by a device for reproducing audio and/or video data, such that audio, video, and/or A/V navigation data are arranged in a data structure that meets the specifications.

### BACKGROUND OF THE INVENTION

An additional subject of the present invention is a data carrier, which includes audio, video, and/or A/V navigation data of the carrier in a data structure arrangement that meets at least a predetermined specification, so that the data structure arrangement is configured according to a method according to the invention.

In addition, the present invention relates to a method for using an inventive data carrier by means of a device that meets at least a predetermined specification for copying audio and/or video data and/or a device for capturing an inventive data structure arrangement on the data carrier.

The production of the operation and use of illegally prepared copies, so-called pirated copies, from data carriers of the aforementioned type by means of a device for copying audio and/or video data—so-called players or player systems—which are configured and/or adapted for the use of this type of data carriers, are a continuing problem in the entertainment industry, especially with audio and/or video data operated on CDs and/or DVDs as data carriers. Consequently numerous solutions are known in the art to prevent or at least make more difficult the unauthorized uses of audio and/or video data operated on corresponding data carriers, or else are intended to make such uses uninteresting for potential users of this type of pirated copies of data carriers, especially copy protection measures.

Corresponding data carriers in the form of a so-called CD or DVD have so far been able to be duplicated without great complication, simply and inexpensively, for instance with CD and/or DVD recorders that are widely distributed on computers or computer systems, the so-called CD and/or DVD burners, and, corresponding with these useable writable and/or rewritable optical data carriers, so-called blanks. Use is made of include sector- or file-based copies of manufacturing copier programs, so called ripping programs, as well as tools for analyzing data carriers that are to be copied, or their content—usually also in the form of programs that can be operated by a computer.

With sector-based copies of data carriers in the form of copying programs that provide CDs or DVDs, without a thorough analysis of the structure of the audio, video, and/or A/V navigation information contained on the particular data carrier, all sectors from the first to the last used sector of the data carrier that is to be copied are read in, decrypted if necessary—for instance with so-called CSS (constant scrambling system) data carriers—and then written again on a rewritable data carrier of the specification (CD or DVD).

With file-based copies of copy programs that produce data carriers, copies of all sectors of the data carriers to be copied, which are referenced in the file system of the data carrier to be copied, are decrypted if necessary—for instance with so-called content scrambling systems (CSS) data carriers—and then written again on a writable data carrier, using the file system of the data carrier that is to be copied.

With so-called ripping copies of ripping programs that produce data carriers satisfying the DVD-video specification, the structure and/or navigation structure of the data carrier to be ripped is analyzed. With the resulting information it is possible, with a standard commercial data carrier of the DVD-video specification, to copy only the areas that are actually used and/or at least to make available to the user possibilities for selecting portions of the data of the data carrier to be copied and/or ripped, in particular to copy or be able to copy at least the portions of the data carrier that are important or interesting to the particular user

Usually in the form of programs to be carried out by a computer, tools that are used by data carriers that are to be copied or whose contents as a rule allow extraction of information necessary for providing a copy of a data carrier and/or for adapting this information to produce a copy. The way these tools work is thus similar to that of so-called ripping programs, but usually more detailed in terms of analysis, in particular concerning the navigation structure of a data carrier. In addition, as a rule, for experts with solid background knowledge of the particular specification of the data carrier, there is the possibility of making manual adaptations.

With the data carriers known in the art, according to the DVD, HD-DVD, and/or Blue Ray specifications, it is possible to cryptographically encrypt the audio, video, and/or A/V navigation data before it is positioned on the data carrier with an algorithm for a predetermined specification so that such audio, video, and/or A/V navigation data captured in such encrypted manner on the data carrier can be copied exclusively by a device for copying such data carriers that also meets the predetermined specifications. Here the audio, video, and/or A/V navigation data, which have been cryptographically decrypted and captured on the data carrier, are accordingly encrypted and copied by the copying device.

The disadvantage of this cryptographic protection of audio, video, and/or A/V navigation data is that—especially in using a DVD as data carrier—it can be captured only on data carriers produced mechanically in great numbers, but not on data carriers that are writable in the standard commercial manner, because some of the areas required for this are not accessible for writing on writable data carriers.

It is also true for all types of media as data carriers, in terms of the present invention, that a cryptographic protection becomes ineffective as soon as the corresponding specification and the cryptographic elements used by or with it become publicly available. Because every copying device (or player) must be able to perform the actions necessary for decoding the particular data stream, the general opinion is that every cryptographic copy protection system can and will, sooner or later, be broken and/or circumvented by decoding.

Despite constant technical refinements, the protection provided by copy protection measures and systems known and cited so far, to prevent copying of the data carrier for audio and/or video data operated on a data carrier of the aforementioned kind, is insufficient and, as a rule, can still be circumvented and/or removed relatively easily.

### SUMMARY OF THE INVENTION

In view of this state of the art, it is the object of the present invention to improve the protection against improper copying of audio, video, and/or A/V navigation data that can be captured by means of a data carrier of a predetermined specification that can be used by a device for reproducing audio and/or video data, such that audio, video, and/or A/V navigation data are arranged in a data structure that meets the specifications.

To provide a technical solution for this object, according to the present invention a method is proposed for protection against improper copying of audio, video, and/or A/V navigation data that can be captured by means of a data carrier of a predetermined specification that can be used by a device for reproducing audio and/or video data, such that audio, video, and/or A/V navigation data are arranged in a data structure that meets the specifications, and said method is characterized by at least one modification of at least a portion of the audio, video, and/or A/V navigation data that are to be protected in the data structure arrangement.

The invention is based on the recognition that by means of at least one inventive modification, at least one portion of the audio, video, and/or A/V navigation data to be protected in the data structure arrangement, a copy protection can be provided that prevents, or at least makes considerably more difficult, any particularly improper copying of a data carrier provided with the data structure arrangement. The inventive modifications here can advantageously be an integrative component of the data structure arrangement that is to be protected by means of a data carrier. The inventive modifications have the advantage that they are transparent for a device that uses the data carrier for copying audio and/or video data, that is, in particular in such a way that the data carrier can be used by the copy device as agreed and during the period of operation of the copying of audio and/or video data by the copy device, its functions are not impaired. The modifications in the audio, video, and or navigation data in the data structure arrangement here satisfy the specification of the data structure arrangement and are accordingly can be used by the copy devices by means of corresponding data carries as agree, although they differ advantageously from the data structure arrangement of the specification that is in conventional use or is usable in that copying is prevented or at least made considerably difficult.

An advantageous embodiment of the invention is characterized by at lest one modification aimed at enlarging the physical and/or logical storage requirement of at least one portion of the audio, video, and/or A/V navigation data to be protected in the data structure arrangement. As a result of these inventive modifications, the storage requirement for the audio, video, and/or A/V navigation data to be protected is physically and/or logically expanded so that corresponding copy programs and/or systems meeting the specification of the data carrier cannot perform the copying of a data carrier that includes an inventive data structure arrangement, because such a carrier is or would become too large and/or invalid physically and/or logically with respect to the required storage space.

An inventive modification thus expands the absolutely used storage area of the data carrier and, in an advantageous embodiment using the maximum available storage capacity of the data carrier, prevents a sector-bases 1:1 copying onto other smaller data carriers. An advantage here is that, in particular with optical data carriers such as CDs and DVDs, the capacities of the individual Rohling types are clearly diverse. According to the invention, depending on the employed size of the data carrier serving as the original, a great number of data carriers provided for possible sector-based 1:1 copying are no longer used.

The inventive modifications of at least a portion of the audio, video, and/or A/V navigation data to be protected in the data structure arrangement are advantageously not able to be distinguished from regularly existing audio, video, and/or A/V navigation data because of their enclosure in the structure of the file system of the data carrier by means of the directories and/or files of audio, video, and/or A/V navigation data. Consequently a copy program that produces file-based copies would try to copy these areas, which are present merely logically but not physically, leading automatically to errors and, depending on the configuration of the copy program or the device using it, to an interruption of a copying process.

According to an additional proposal of the invention, a modification occurs through at least one addition of extra audio, video, and/or A/V navigation data to audio, video, and/or A/V navigation data that are to be protected in the data structure arrangement. Advantageously here, at least one portion of audio, video, and/or A/V navigation data that are to be protected is copied at least once and added as extra audio, video, and/or A/V navigation data. The added audio, video, and/or A/V navigation data are, in a preferred embodiment of the invention, are referenced by means of the data structure arrangement at least once physically and/or at least once logically. Another embodiment of the invention is characterized by a logical referencing by means of at least one portion of the navigation data of the data structure arrangement. A logical referencing by means of the navigation structure of the data structure arrangement is preferred.

Thus, according to the invention, audio, video, and/or A/V navigation data are at least partly added to the data structure arrangement, so that the data are present in the data carriers file system at least in or with the capture by means of a data carrier. Here the data structure arrangement or the file system of the data carrier includes existing and/or nonexistent audio, video, and/or A/V navigation data in the form of files of audio, video, and/or A/V navigation data ordered in a structured directory. In the final result, thanks to these measures—individually and/or in combination with one another—the data structure arrangement or the data carrier is consequently, at least logically, too large to be copied. On the basis of an analysis of the data structure arrangement or of the file system of a corresponding data carrier, it is advantageously impossible here to recognize which directory or which portion of a directory is the original or which is the copy.

The files of audio, video, and/or A/V navigation data added in this manner according to the invention—as described above—cannot be distinguished from regularly present audio, video, and/or A/V navigation data that are to be protected because of their inclusion in the structure of the file system of the data carrier by means of the directories and/or files of audio, video, and/or A/V navigation data. As explained above, a file-based copy program producing copies would accordingly attempt to copy these logically but not physically present areas, leading automatically to errors and, depending on the configuration of the copy program or the device that uses this program, to the interruption of a copying process.

Such inventive modifications, in particular by means of the file system of a data carrier that meets DVD specification, are used in connection so-called title sets as at least one portion of a directory and so-called titles as files and/or file series with reference to the directory of the file system of the data carrier. The inventive modification of a data carrier that meets a DVD specification would accordingly produce virtual title sets and/or virtual titles.

In the context of an inventive addition of audio, video, and/or A/V navigation data and their inventive referencing, there is advantageously an adjustment at least of the navigation data of the added audio, video, and/or A/V navigation data. Advantageously, in the context of the adjustment, storage space areas not physically existing on the data carrier are referenced. In this preferred embodiment of the invention this occurs by the selection of a starting address and/or of a so-called offset in the navigation data and/or of an entry of the starting address and/or of a so-called offset in the file system structure for an initial storage space area that includes audio, video, and/or A/V navigation data, which area is advantageously placed after or behind the physical end for storage areas of a data carrier that meets the specification.

In an advantageous embodiment of the invention, the navigation data are adjusted in the context of an inventive modification in such a way that the added area is logically known in the navigation but a copy device during a copying in a customary running time range could never reach this area. With a CD as data carrier, this occurs advantageously through application of the TOC entry that corresponds to the added area, into a second or following session, which is not evaluated by customary CD copy devices. With DVD, HD-DVD, or Blu-Rays as data carriers, the adjustment occurs by the addition of one or more file system entries corresponding with the added area, and of corresponding entries in the TT SRPT- and VTS ATRT-structures of the IFO files of the so-called VMG (video manager). Advantageously here, in the structures that control the process of copying, the so-called program chains (PGCs), references, preferably in the form of jumps, are added or inserted into the added areas, which however in the normal running time range of a copy device are never executed. A preferred embodiment of the invention provides that PGCs for this are used purpose, which themselves are not referenced. An additional embodiment provides that references instead of PGCs are used, which then, because of appropriate measures, in particular conditional and/or unconditional jumps around the corresponding reference an/or out of the corresponding PGC, are never executed. A particularly preferred embodiment of the invention foresees that these leaps, which depend on the running time of computed variables, occur in registers, for instance GPRM registers. Corresponding variables of the registers can be predetermined by copy programs and/or similar devices only at considerable cost or not at all, so that an additional improvement is provided with respect to unauthorized copying.

With common copy programs the compression of entered audio, video, and/or A/V navigation data is foreseen, especially to allow a better data transfer by communication networks such as the Internet or on data carriers of a predetermined maximum size concerning its storage area or space. Because corresponding audio, video, and/or A/V navigation data that are to be entered by some data structure arrangements of predetermined specifications are present in compressed form—usually compressions on DVDs, HD-DVDs, or Blu-Ray Discs of audio and/or video data are in compressed data formats such as MPEG-2, VC-1, and/or H.264-corresponding copy programs must be able, at least partially at first, to decompress the original audio and/or video data that are to be entered.

In an especially advantageous embodiment of the invention several logical references are present on physically non-present audio, video, and/or A/V navigation data, which, with a copy program and/or similar device that has the capability or the configuration of being able to ignore errors, has nevertheless as a consequence that a copy process at such a site is not interrupted but is at least slowed down many-fold, preventing effective copying even in the case of a high tolerance for errors. An additional particularly advantageous embodiment of the invention provides, in connection with the use of data carries according to a DVD, HD-DVD, and/or Blu-Ray specification, that, in the context of a modification occurring through the addition of audio, video, and/or A/V navigation data these include at least in some cases data that, in the decompression that meets the particular specifications, cause errors on the part of the device copying the data carriers, leading to the interruption of a copying process. Thus, for instance, motion vectors pointing to invalid areas of a data carrier can be can be left in the so-called MPEG basing video data. A consequence of the presence of several logical references on the audio, video, and/or A/V navigation data is that copy programs and/or similar devices with the capability and/or the configuration of an error tolerance can execute a copying process in any case slowed down by many-fold and/or with a reduction in quality because of a high compression cost and/or factor that is required to achieve a size specification, so that effective copying is prevented or made considerably more difficult even in the case of a heightened error tolerance.

Another advantageous embodiment of the invention is characterized by a division of at least part of the audio, video, and/or A/V navigation data that are to be protected into at least two units foreseen by the specification with special use functions (ILVUs or interleaved video units) for audio and/or video data and adjustment of the navigation data of the divided audio, video, and/or A/V navigation data that are to be protected, corresponding to the division into the at lest two units foreseen by the specification with special functions (ILVUs) for audio and/or video data as modification. According to an additional proposal of the invention, an additional addition of data, preferably audio and/or video data, is foreseen in unused units on the part of the foreseen specification with special use functions (ILVUs) for audio and/or video data. A preferred embodiment of the invention is characterized by angle and/or seamless branching functionalities as special use functions of units (ILVUs or interleaved video units) for audio and/or video data foreseen by the specification.

An additional advantageous embodiment of the invention is characterized by at least one change in the navigation structure of the data structure arrangement as modification. A preferred embodiment of the invention is characterized by at least one physical and/or logical displacement of at least part of the audio, video, and/or A/V navigation data to be protected by the data structure arrangement as a modification that changes the navigation structure of the data structure arrangement. As a result of the inventive displacements it is not possible for a copy program and/or similar device to identify the logically and/or physically present directory information present by means of the file system structure of the data carrier in the form of audio, video, and/or A/V navigation data as the audio, video, and/or A/V navigation data (original data) that are to be protected, in that it accepts, for instance, as original data the data that lie logically and/or physically at the start of the data structure arrangement.

According to another advantageous proposal of the invention, a physical and/or logical displacement occurs by using a predetermined algorithm, according to which audio, video, and/or A/V navigation data are positioned accidentally at another physical position of the data structure arrangement and/or of the file system structure of the data carrier and the corresponding file system entries of the navigation data of audio, video, and/or A/V navigation data are adjusted accordingly. The audio, video, and/or A/V navigation data that are to be protected are advantageously are newly identified according to the algorithm with respect to their navigation in the file system structure, for instance in connection with so-called IFO files in a DVD specification. For this purpose the so-called TT-SRPT and VTS-ATRT structures are modified or produced, for instance on DVDs, HD-DVDs, or Blu-Ray discs, in such a way that original file names or titles cannot be identified by a copy program on the basis of their positions by means of data carriers or of the file structure of the data carrier. Advantageously here, the structures that reference the titles, the so-called program chains (PGCs) are correspondingly modified, preferably in such a way that every reference to a changed entry in the TT-SRPT or VTS-ATRT structures are changed in each case to the new reference.

Another preferred embodiment of the invention is characterized by at least one division of at least one program chain (PGC) that references at least one chapter of a title through programs, into at least two PGCs and adjustment of the navigation data of the divided PGCs corresponding to the division into the at least two PGCs as a modification that alters the navigation structure of the data structure arrangement.

A particularly preferred embodiment of the invention is characterized by a replacement of an original PGC by at least two PGCs, so that at least the first PGC refers in the context of its navigation to a succeeding PGC, which in turn contains the programs (chapter) of the original PGC as well as at lest one added program (chapter). The navigation references of the first PGC to the succeeding PGC do not go to the PGC as such and thus to the added program (chapter), but refer to the succeeding programs, which are thus taken over by the original PGC. The remaining navigation structure of the data structure arrangement is adjusted advantageously to the PGCs modified in this way.

According to an additional proposal of the invention, at least one addition of audio, video, and/or A/V navigation data to audio, video, and/or A/V navigation data to be protected and referencing of the added audio, video, and/or A/V navigation data that depend at least on one condition in the context of a program of PGC that contains at least one program, is foreseen as a modification that alters the navigation structure of the data structure arrangement. Advantageously the condition with authorized use of the data structure arrangement cannot be fulfilled with a data carrier by means of a copy device.

Another advantageous embodiment of the invention is characterized by at least one self-referencing of at lest one PGC that includes at least one program, as a modification that alters the navigation structure of the data structure arrangement. Advantageously the at least one PGC cannot be executed with authorized use of the data structure arrangement with a data carrier by means of a copy device.

According to a further advantageous embodiment of the invention, in the context of the modification, data in the data structure arrangement are foreseen which cannot be used, when captured on a data carrier, in the data structure arrangement in at least one area of the data carrier at least for a device for reading and thus copying audio and/or video data. Examples of such inventive modification are known in the art, for instance from U.S. 2005/0193313 A1, to whose disclosures reference is made here. The present invention advantageously foresees that data, when the data structure arrangement is captured on a data carrier, at least cause problems in controlling the device for reading audio and/or video data. Advantageously, the audio, video, and/or A/V navigation data are added in the framework of an inventive modification. The inventively added data that are not usable for the device for reading audio and/or video data of non-usable data are advantageously adjusted by the data structure arrangement on the part of the data carrier or its file system structure in such a way that the data are also physically added to the data carrier. Advantageously this occurs through an entry in the directory or the file system structure of the data carrier that references the corresponding data, as well as corresponding entries in the navigation data of the data structure arrangement on the part of the data carrier.

Another advantageous embodiment of the invention is characterized by tolerance areas foreseen before and/or after the area with data that are not usable by the device for reading audio and/or video data, with audio, video, and/or A/V navigation data. Advantageously the audio, video, and/or A/V navigation data of tolerance areas are audio, video, and/or A/V navigation data that are generated in the context of an inventive modification. Data that constitute a protection area and cannot be used by a device for reading audio and/or video data for copying purposes consist advantageously of an initial tolerance area with normal data material that is adjusted to the particular data carrier and the correct specification, followed by data that cannot be read with commercially available devices for reading audio and/or video data for copying purposes, data which, in an attack by the device for copying audio and/or video data, result in reading errors and are concluded by an end tolerance area that includes data material adjusted to the particular data carrier and the correct specification.

In a preferred embodiment of the invention, the data are configured in the form of non-readable sectors, which are produced by a special data model, preferably with an algorithm that uses the data model. Corresponding algorithms, for instance the so-called recording codes or modulation codes, for instance EFM (eight to fourteen modulation) with CDs or EFMPlus with DVDs, are conventionally used in order to be able to read safely, or to make readable, data that are to be place or are placed on a data carrier. The inventive use of a special data model, by using the aforementioned algorithms, produces data models that run counter to this, contrary to the actually desired effectiveness of the so-called recording codes or modulation codes and thus precisely prevent legibility. The non-readable areas produced inventively in this manner, with conventionally available devices for reading data carriers for copying purposes, lead to reading errors and copying is accordingly prevented or at least made definitely more difficult.

Advantageously the at least one invention modification occurs before and/or with the transmission of the data structure arrangement of audio, video, and/or A/V navigation data that are to be protected by means of a communication network, preferably the Internet.

An additional embodiment of the invention provides that the at least one modification occurs in the framework of the device of the audio, video, and/or A/V navigation data on a data carrier.

A preferred embodiment of the invention foresees that the data carrier meets at lest one specification, preferably the DVD video specification, the HD-DVD specification, and/or the Blu-Ray specification.

Another subject of the present invention is a data carrier, which includes audio, video, and/or A/V navigation data in a data structure arrangement that meets at least one predetermined specification and is characterized in that the data structure arrangement is configured according to an inventive method. In a specially preferred embodiment of the invention, the data carrier is a medium according to DVD-R, DVD-RW, DVD+R, or DVD-+RW that can be written at least once.

In addition another subject of the present invention is a method for using an inventive data carrier by means of the device meeting at least one predetermined specification for copying audio and/or video data and/or a device for capturing a data structure arrangement according to an inventive method on the data carrier.

Additional details, characteristics, and advantages of the invention are presented in greater detail hereafter with reference to the description of preferred embodiments of the invention.

### BRIEF DESCRIPTION OF THE DRAWINGS

FIG. 1 shows in a schematic principle representation an embodiment of an inventive file-based modification of a directory of a data carrier that meets the DVD specification.

FIG. 2 shows in a schematic principle representation an embodiment of an inventive file-based modification of a title of a data carrier that meets the DVD specification.

FIG. 3 is shows in a schematic principle representation an embodiment of an inventive file-based modification of a file, which includes video data, of a data carrier that meets the DVD specification.

FIG. 4 shows in a schematic principle representation an embodiment of an inventive file-based modification of a file, which includes audio data, of a data carrier that meets the DVD specification.

FIG. 5 shows in a schematic principle representation an additional embodiment of an inventive modification of a title of a data carrier that meets the DVD specification, primarily through parts of the navigation structure of audio and/or video data that are to be protected.

FIG. 6 shows in a schematic principle representation an embodiment of an inventive modification by insertion of navigation data.

FIG. 7 shows in a schematic principle representation an additional embodiment of a program of a referencing of data inserted by inventive modification but unused.

FIG. 8 shows in a schematic principle representation a program diagram of an embodiment of a self-referencing through inventive modification, primarily through changing the navigation structure.

### DETAILED DESCRIPTION OF THE INVENTION

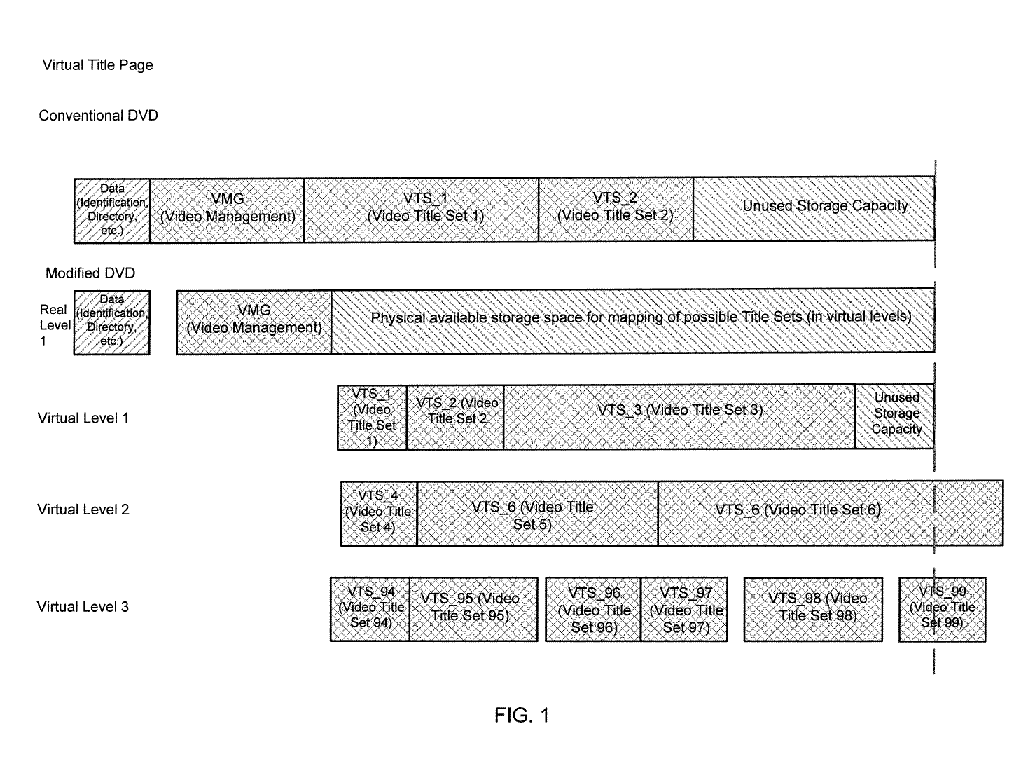

FIG. 1 shows in a principle representation the structure of a file system of a data carrier that meets the DVD specification before (traditional DVD) and after (modified DVD) a modification of the directory of audio, video, and/or A/V navigation data of the DVD that are to be protected. By means of the file system of the DVD, various files of audio, video, and/or A/V navigation data (VTS_1 [video title set 1], VTS 2 [video title set 2], as well as unused storage space area through a physical data carrier are present, in addition to the data (data [identification, directory, etc.]), data that organize video data [VMG video manager]).

In the framework of the modification the directory of the DVD is copied and added to the data (identification, directory, etc.). In the process, in the added directory, files of audio, video, and/or A/V navigation data are referenced, which turn up primarily in the file system of the data carrier purely logically in virtual planes and thus virtually depict the data carrier as logically too large for copying. An analysis of the file system of the modified data carrier does not allow recognition here of which of the files (VTS 1 [video title set 1] to VTS 99) are real, i.e. truly provided for use, or virtual, i.e. unusable or not usable for the intended purpose

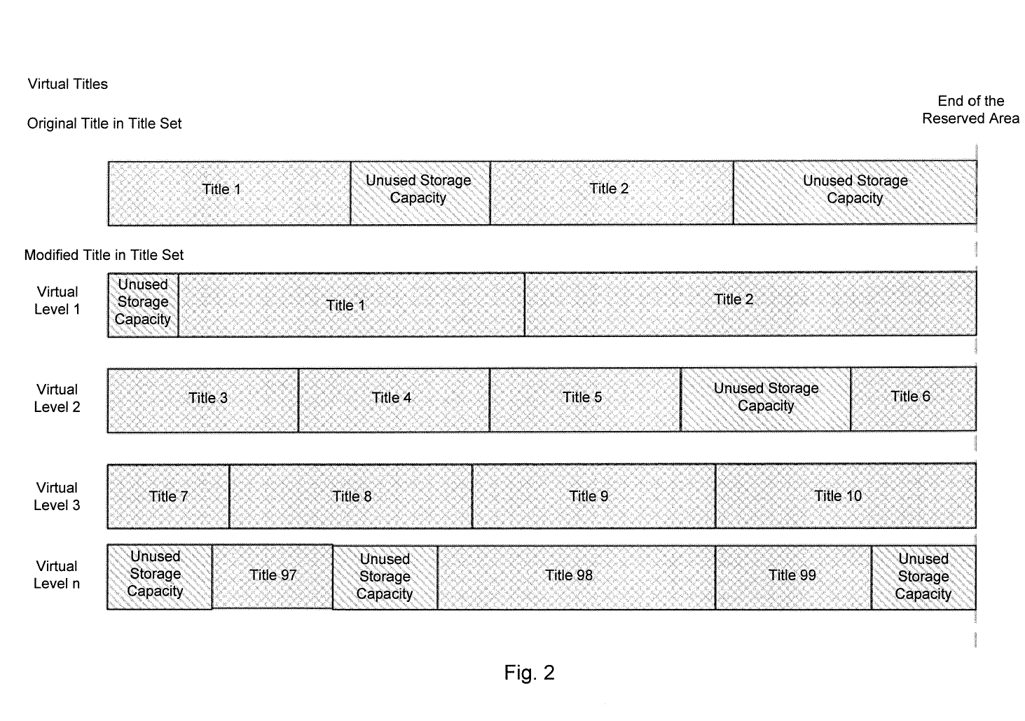

The embodiment depicted in FIG. 2 shows a modification that occurs through the addition of titles of audio, video, and/or A/V navigation data. Here, starting from titles that include the files of audio, video, and/or A/V navigation data that are to be protected, primarily title 1 and title 2, additional files (title 3 to title 99) are added to the data structure arrangement of a traditional DVD (traditional title in the title set) in the framework of the modification (modified title in the title set).

Addition of the titles (title 3 to title 99) occurs in such a way that an exhaustion of the maximum available storage capacity of the data carrier advantageously occurs. This ensures, in particular, that sector-based 1:1 copies onto smaller data carriers are to the greatest extent impossible.

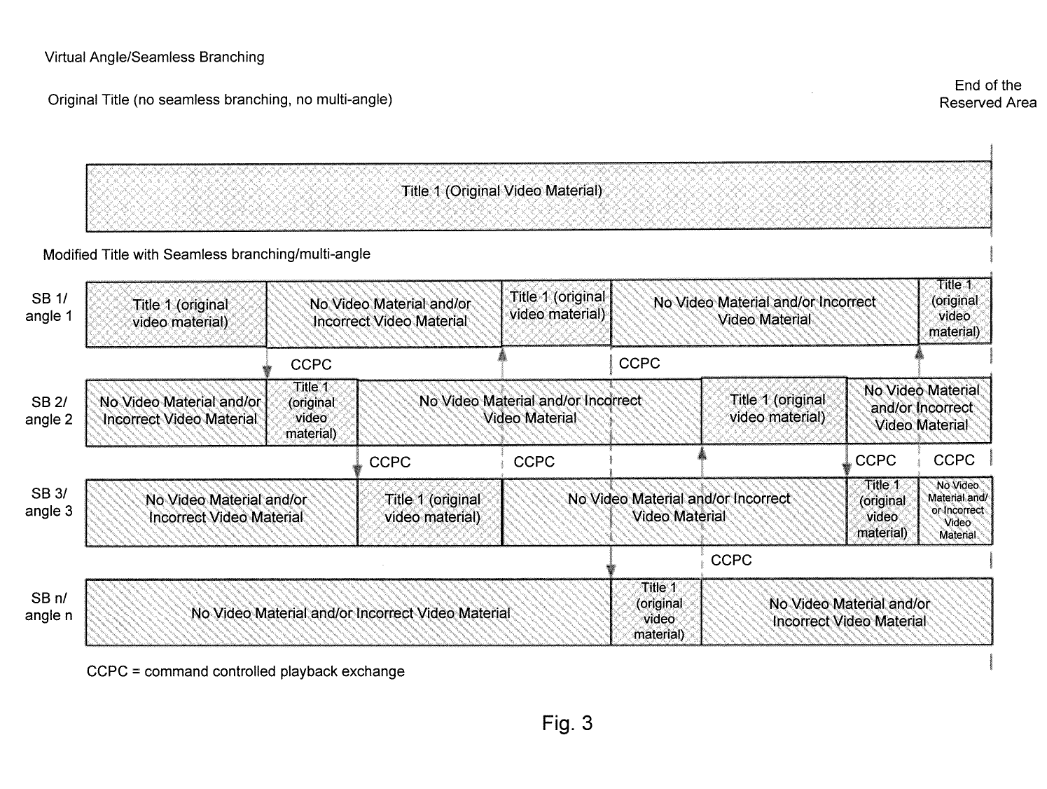

FIG. 3 in a schematic principle representation shows an embodiment of an inventive modification by changing at least one portion of a file of audio, video, and/or A/V navigation data. Here a file of video data that is to be protected is provided in the framework of the modification with possibilities, foreseen by the DVD-video specification of data carriers, of a so-called angle and/or of a so-called seamless branching. The video data here are modified in such a way that normal, so-called single-angle video sequences are distributed over several angles or ILVUS (interleaved video units) of the DVD specification. The navigation data of the corresponding video data that are apply here are modified by changing the PGC commands in such a way that the angles are switched seamlessly, i.e. in a manner not noticeable during the copying for the user. The switching processes are depicted in FIG. 3 as CCPC (command controlled playback change), so that there is a jumping back and forth between the original video data divided among the various angles, corresponding to the original sequence of the video data on the part of the original file. For copy programs that do not support copying of data corresponding to an ILVU functionality, primarily an angle functionality, it is impossible or at least difficult to ascertain the correct ILVU or the correct angle or the corresponding transitions between them.

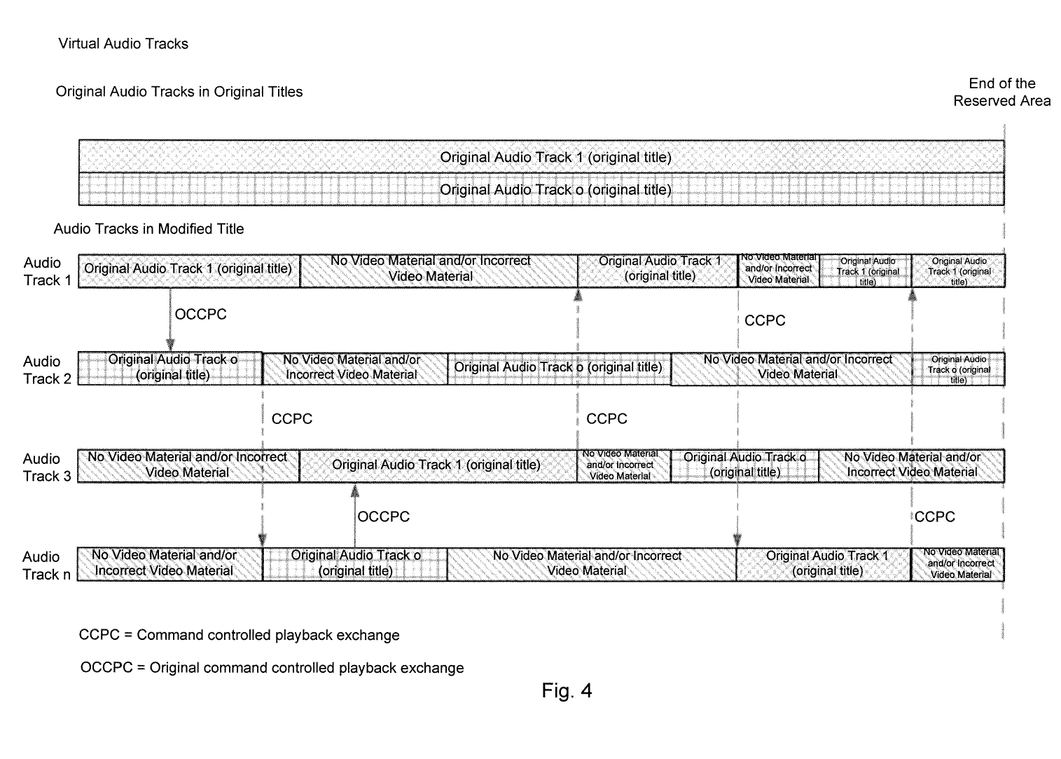

FIG. 4 shows an additional embodiment of a modification of files of data of an inventive data carrier. What primarily occurs here is a modification of a file of audio data by distributing the original audio data and adding falsified audio data. The original audio data of a file here are at least partly captured on a data carrier that meets a DVD specification and the its navigation is changed in such a way that the original audio data can be played back by means of CCPC and/or OCCPC (original command controlled playback change). The added falsified audio data can contain meaningless and/or incorrect audio information. Selection of the correct tone track for copying the data carrier is complex for traditional copy programs and also can be established only with difficulty upon extensive analysis. In the framework of the playback of the file of audio data also in modified condition, thanks to so-called user restrictions it is advantageously not possible for the added falsified audio material to achieve false audio data in the authorized use of data carriers by a copy device.

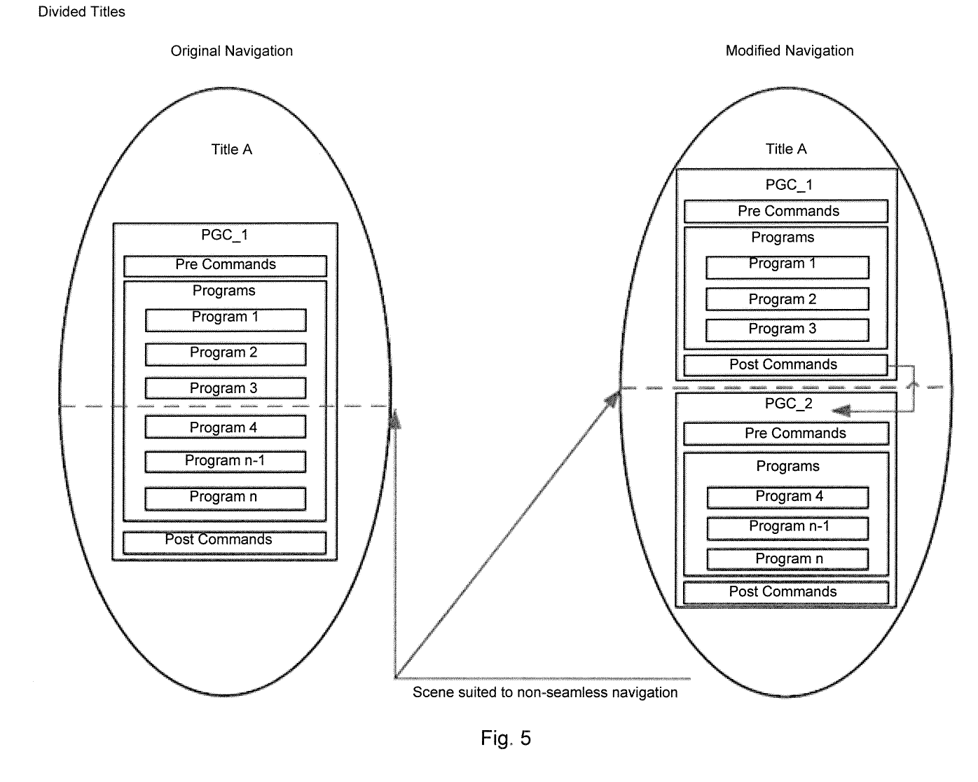

FIG. 5 shows an additional modification of a data carrier that meets a DVD specification. Here, primarily, the programs (n programs [chapters]) realized through a single program chain (PGC 1) and representing title navigation by chapter, upon modification are distributed in the original navigation into two program chains (PGC 1 and PGC 2) in the modified navigation. The first modified program chain (PGC 1) includes the navigation over the first three programs (programs 1, 2, 3) of a chapter and branches at the end automatically into three program chain (PGC 2), which assumes the navigation of the remaining n−3 programs of a chapter. Because the transition between the modified program chains PGC 1 and PGC 2 can lead to slight delays concerning the player or the copy device (non-seamlessly), in a preferred embodiment the transition between the two program chains (PGC 1 and PGC 2) is to be selected in such a way that the observer fails to notice a brief jerking. This occurs, for instance, by positioning such a division of the program chains in the area of a scene change or a very dark video sequence. In addition, all references made from outside the named program chains to their programs must refer to the new program chains and correspondingly must be re-referenced to the new structure of the program chains. Thus it is not possible, as is the practice with a few copy programs, to select the complete audio and/or video data of the original program chain by selecting data associated with one program chain.

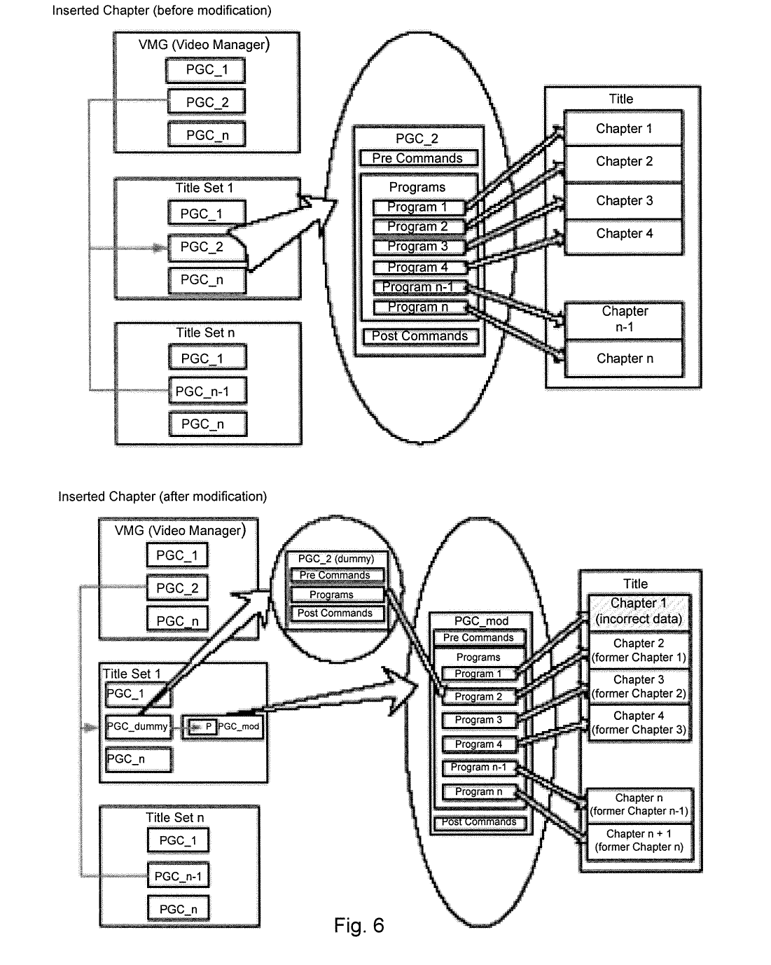

FIG. 6 shows an inventive modification by insertion of audio, video, and/or A/V navigation data into data positioned in the navigation structure as chapters. Here, starting from a navigation structure of the video manager (VMG) and the associated title sets in at least one part of a title set, primarily in title set 1, [data are] inserted in a program chain, primarily the so-called PGC dummy, which refers to a new PGC dummy positioned by the navigation structure. Reference is made by the modified PGC (PGC mod) to audio, video, and/or A/V navigation data, such that new data are added (chapter 1) to the original files of audio, video, and/or A/V navigation data that are to be protected of the same existing files (originally chapter 1 to chapter n) of the original title. The corresponding original chapter 1 to chapter n of the original title must accordingly be re-referenced in the framework of the modification in their sequence and accordingly become chapter 2 (former chapter 1) to chapter n+1 (former chapter n). Accordingly the corresponding programs (program 1 to program n) are re-referenced by the PGC mod in comparison to the original programs (program 1 to program n). In addition all original references are re-referenced by the program chain PGC 2 to the newly created program chain PGC dummy. The data added as a new chapter (chapter 1) are to be created here deliberately in such a way that they provide maximum hindrance to copy programs, for instance through reader failure or non-compressible data. Data added in the framework of an inventive modification can also include more than one chapter and must no necessarily be found at the start of the data structure arrangement. The program chain PGC mod is necessary so that copy devices at chapter 2 start the original chapter 1.

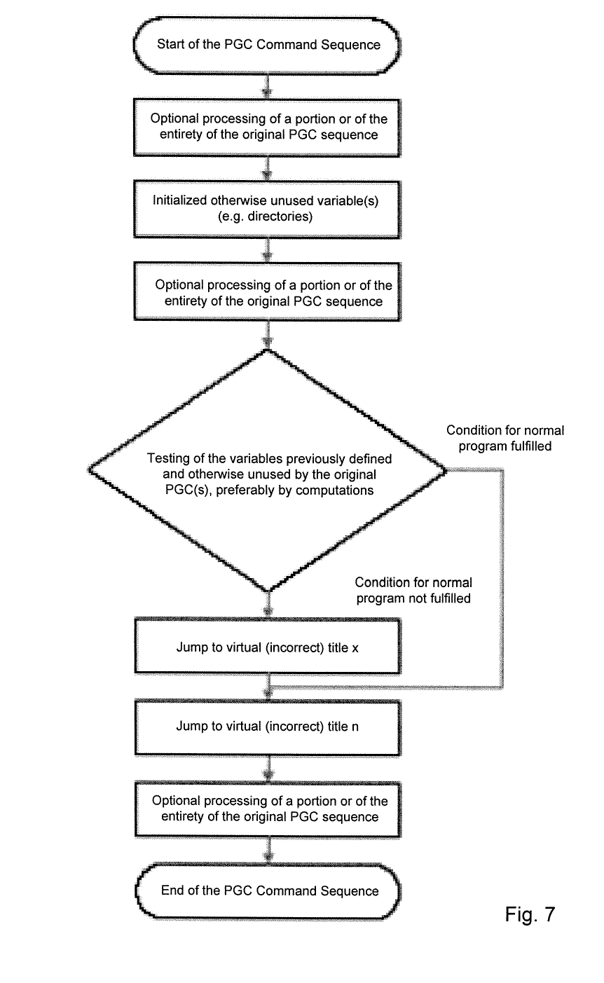

FIG. 7 shows a program diagram for a corresponding referencing of files of audio, video, and/or A/V navigation data in the framework of a modification of data of a data carrier that meets a DVD-video specification. This provides primarily, by way of example, a referencing to unused data files of audio, video, and/or A/V navigation data added by the data carrier in the framework of an inventive modification. The data of audio, video, and/or A/V navigation data referenced here are, in the embodiment illustrated in FIG. 7, are purely virtual, that is merely logically present on the part of the navigation structure, and thus are recognized by a linearly working analysis program as present, but are not used during a working process by a copy device.

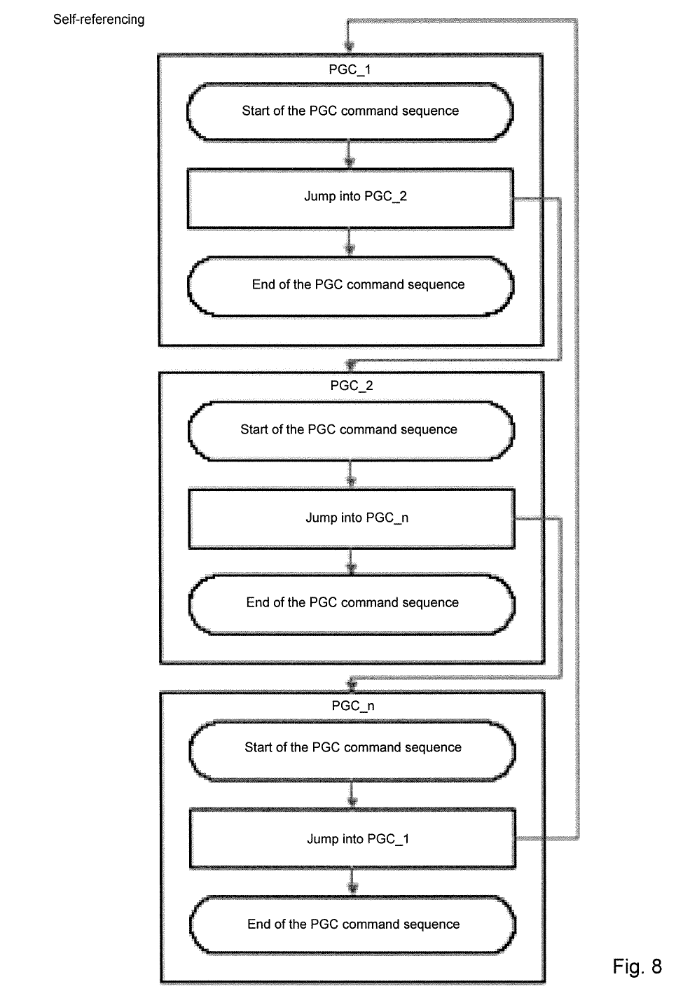

FIG. 8 shows an additional embodiment of an inventive modification, primarily with the data carrier adding navigation data that reference themselves. FIG. 8 shows the self-referencing whereby PGC 1 jumps into PGC 2, PGC 2 jumps into PGC n, and finally PGC n jumps back into PGC 1. This creates an endless jump sequence, so that in an attempted copying procedure by imitation of the original navigation behavior of the PGCs referenced by the data carrier and the data of audio, video, and/or A/V navigation data that are thus logically and/or physically connected, devices that produce corresponding copies are hung up in an endless loop or interrupt the copy process after a certain period of time with corresponding error tolerance.

The described embodiments of the invention and the embodiments of the invention illustrated in connection with the drawings serve only to explain the invention and are not restrictive with respect to it. Thus the embodiments presented and described here are also capable of repeated and combined use, so that the number of modifications that hinder or prevent copying procedures can be configured and designed very extensively.

1. A method for protecting against copying of audio, video, and/or A/V navigation data that can be captured by means of a data carrier of a predetermined specification that can be used by a device for reproducing audio and/or video data, such that audio, video, and/or A/V navigation data are arranged in a data structure that meets the specifications characterized by at least one modification of at least one portion of audio, video, and/or A/V navigation data that are to be protected in the data structure arrangement.

2. A method according to claim 1, characterized by at least one modification concerning an enlargement of the physical and/or logical storage place requirement of at least one portion of audio, video, and/or A/V navigation data in the data structure arrangement.

3. A method according to claim 1, characterized by at least one addition of additional audio, video, and/or A/V navigation data to audio, video, and/or A/V navigation data that are to be protected in the data structure arrangement as a modification.

4. A method according to claim 3, characterized in that at least one portion of audio, video, and/or A/V navigation data that are to be protected is copied at least once and added as addition audio, video, and/or A/V navigation data.

5. A method according to claim 3, characterized in that the added audio, video, and/or A/V navigation data are referenced at least once physically and/or at least once logically by the data structure arrangement.

6. A method according to claim 6, characterized by a logical referencing by at least one portion of the navigation data of the data structure arrangement.

7. A method according to claim 5, characterized by a logical referencing by the navigation structure of the data structure arrangement.

8. A method according to claim 1, characterized by a division of at least one portion of audio, video, and/or A/V navigation data that are to be protected into at least two units foreseen by the specification with special use functions (ILVUs or interleaved video units) for audio and/or video data and adjustment of the navigation data of the divided audio and/or video data that are to be protected corresponding to the division into the at least two units foreseen by the specification with special use functions (ILVUs) for audio and/or video data as modification.

9. A method according to claim 8, characterized by an additional addition of data, preferably of audio and/or video data, in unused units foreseen by the specification with special use functions (ILVUs) for audio and/or video data.

10. A method according to claim 1, characterized by at least one change in the navigation structure of the data structure arrangement as a modification.

11. A method according to claim 10, characterized by at least one physical and/or logical displacement of at least a portion of audio, video, and/or A/V navigation data that are to be protected by the data structure arrangement as a modification that changes the navigation structure of the data structure arrangement.

12. A method according to claim 10, characterized by at least one division of at least one program chain (PGC) that references at least one chapter of a title by programs in at least two PGCs and adjustment of the navigation data of the divided program chain corresponding to the division into the at least two PGCs as a modification that alters the navigation structure of the data structure arrangement.

13. A method according to claim 10, characterized by a replacement of an original program chain (PGC) by at least two PGCs, such that at least the first PGC refers in the framework of its navigation to a succeeding PGC, which in turn contains the programs (chapters) of the original PGC as well as at least one added program (chapter), such that the navigation references of the first PGC preferably go to the succeeding PGC and thus not to the PGC as such and thus to the added program (chapter), but rather to the succeeding program (chapter) and thus the one taken over by the original PGC, such that the remaining navigation structure of the data structure arrangement is preferably adjusted to the PGC modified in this way.

14. A method according to claim 10, characterized by at least one addition of audio, video, and/or A/V navigation data to audio, video, and/or A/V navigation data that are to be protected and referencing of the added audio, video, and/or A/V navigation data that depend at least on a condition in the framework of a program of PGC that includes at least one program as a modification that alters the navigation structure of the data structure arrangement.

15. A method according to claim 14, characterized in that the condition in the authorized use of the data structure arrangement cannot be fulfilled with a data carrier by a copy device.

16. A method according to claim 10, characterized by at least one self-referencing of at least one program chain (PGC) that includes at least one program as a modification that alters the navigation structure of the data structure arrangement.

17. A method according to claim 16, characterized in that the at least one program chain with authorized use of the data structure arrangement with a data carrier cannot be executed by a copy device.

18. A method according to claim 1, characterized in that in the framework of the modification, data are foreseen in the data structure arrangement which, when captured on a data carrier, are not usable in the data structure arrangement in at least one area of the data carrier at least for a device for reading audio and/or video data.

19. A method according to claim 18, characterized in that the data of the data structure arrangement when captured on a data carrier cause at least problems in controlling the device for reading audio and/or video data.

20. A method according to claim 18, characterized by foreseen tolerance areas with audio, video, and or navigation data before and/or after the area with data that are not usable by the device for reading audio and/or video data.

21. A method according claim 20, characterized in that the audio, video, and/or A/V navigation data of the tolerance areas are audio, video, and/or A/V navigation data which are generated in the framework of the modification.

22. A method according to claim 1, characterized in that the at least one modification before and/or with the transmission of the data structure arrangement of audio, video, and/or A/V navigation data to be protected occurs over a communication network, preferably the Internet.

23. A method according to claim 1, characterized in that the at least one modification in the framework of the arrangement of audio, video, and/or A/V navigation data occurs on a data carrier.

24. A method according to claim 1, characterized in that the data carrier meets at least one specification, preferably the DVD-video specification, the HD-DVD specification, and/or of the Blue-Ray specification.

25. A data carrier, which includes audio, video, and/or A/V navigation data in a data structure arrangement that meets at least one predetermined specification, characterized in that the data structure arrangement is configured according to a method according to claim 1.

26. A data carrier according to claim 25, characterized in that said data carrier is a medium that can be written at least once, according to DVD-R, DVD-RW, DVD+R, or DVD-+RW.

27. A method for using the data carrier of claim 25 by a device for copying audio and/or video data, which meets at least one predetermined specification, and/or a device for capturing a data structure arrangement on the data carrier.
